(19) United States
(12) Patent Application Publication
(10) Pub. No.: US 2016/0288743 A1
(43) Pub. Date: Oct. 6, 2016

(54) Device for supply of electrical power in a vehicle

(71) Applicant: CONTINENTAL AUTOMOTIVE GMBH, Hannover (DE)

(72) Inventor: Stefan Bieger, Nidda (DE)

(21) Appl. No.: 14/442,589

(22) PCT Filed: Nov. 11, 2013
(86) PCT No.: PCT/EP2013/073524

§ 371 Date: May 13, 2015

(30) Foreign Application Priority Data
Nov. 14, 2012 (DE) 10 2012 220 818.6

(51) Int. Cl. B60R 16/03; H04L 12/10

(52) U.S. Cl. CPC B60R 16/03; H04L 12/10

(57) ABSTRACT

An apparatus for supplying power to a load in a vehicle with a DC voltage source includes: a first connection of the DC voltage source; a second connection of the DC voltage source; and a multicore line configured to transmit voltage from the DC voltage source to the load. The first connection of the DC voltage source is connectable to the multicore line and the second connection of the DC voltage source is connectable to a ground potential.

### CROSS-REFERENCE TO RELATED APPLICATIONS

This is a U.S. national stage of application No. PCT/EP2013/073524, filed on 11 Nov. 2013, which claims priority to the German Application No. DE 10 2012 220 818.6 filed 14 Nov. 2012, the content of both incorporated herein by reference.

### BACKGROUND OF THE INVENTION

1. Field of the Invention

The present invention relates to an apparatus for supplying power to a load in a vehicle with a DC voltage source having a first connection and a second connection and with a multicore line for transmitting the voltage from the DC voltage source to the load, and to a corresponding method.

2. Related Art

It is already known practice to use multicore lines, for example Ethernet cables, to transmit power to a load. IEEE has developed standards for this that involve two (IEEE 802-3af) or four (IEEE 802-3at) wires of an Ethernet cable being able to be used to transmit a voltage to a load. Such a solution is called Power over Ethernet. In order to be able to transmit a power of 10 W to the load, despite the low current carrying capacity of the cable (as per IEEE 802-3af: 350 mA), in the case of interconnection based on the Ethernet standard, a voltage of typically 48 V is used.

The document EP 1 769 315 B1 also discloses supply of power by Ethernet cables. This document explains a method that involves the ascertainment of whether a driven apparatus requires less power being taken as a basis for matching the number of conductor pairs via which the power is transmitted to the power requirement of the driven apparatus.

The above solutions have the problem that either not enough power can be transmitted to a load or the voltage provided by the voltage source needs to be high.

### SUMMARY OF THE INVENTION

Therefore, an object of the present invention is to provide an apparatus for supplying power that can transmit a relatively high power despite the voltage provided by the voltage source being low. Another object is additionally to specify a corresponding method.

The above object is achieved by an apparatus for supplying power having a DC voltage source whose first connection can be connected, or is connected, to the multicore line and whose second connection can be connected, or is connected to a ground potential. In this case, the load is connected to the voltage source via the multicore line.

The solution according to an aspect of the invention allows the positive supply voltage, which corresponds to the first connection, to be fed onto a plurality of wires in the line, preferably onto all wires in the multicore line. Contact with the negative voltage (ground), which corresponds to the second connection, is made by a separate line. In the case of a vehicle, the ground potential is preferably in the form of a vehicle ground, for example in the form of the vehicle bodywork. In this exemplary embodiment, the ground connection of the voltage source is therefore connected to the vehicle bodywork via a separate, preferably single-core line. This allows the cable length required to be reduced, since the vehicle ground is usually available at a short distance from any point in the vehicle.

The voltage source and/or the multicore line preferably has an interface that is arranged in the current path between the first connection of the voltage source and the multicore line.

The ground of the load is likewise at a ground potential, for example the vehicle ground, particularly the vehicle bodywork.

In one preferred exemplary embodiment, the multicore line is in the form of an Ethernet cable. The positive voltage (first connection of the DC voltage source) is transmitted to the individual wires in the Ethernet cable, i.e., at least to 4 wires, preferably at least to 6 wires, particularly preferably to all wires in the Ethernet cable connected in parallel. On the basis of the solution according to the invention, in an automobile, a voltage of 12 V (or 24 V in a truck) between the first and second connections of the voltage source can be used to provide the same amount of power as when using a Ethernet cable in the case of conventional interconnection based on IEEE802-3af and a voltage of 48 V. According to the invention, it is therefore also possible to supply power to power-hungry loads. Apart from the short ground cable, no additional cabling is required in this case.

In a further preferred exemplary embodiment, a respective current limiter is arranged at the feed point for a wire or for a pair of wires in the multicore line. Preferably, the respective current limiter is provided in the interface that is arranged in the current path between the first connection of the voltage source and the multicore line. This is advantageous because the total current can be distributed to the wires in the multicore line unevenly on account of different line resistances. The respective current limiter limits the electric current intensity transmitted to the respective wire or the respective pair of wires to a respectively prescribed maximum value.

The above object is also achieved, for similar reasons, by a method wherein the first connection of the DC voltage source is connected to the multicore line and the second connection is connected to a ground potential.

By way of example, a vehicle according to the present invention is a motor vehicle, such as an automobile, bus or truck, or else is a rail vehicle, a ship, an aircraft, such as a helicopter or airplane, or is an electric bicycle.

### BRIEF DESCRIPTION OF THE DRAWING

Further advantages, features and opportunities for application of the present invention will emerge from the description of an exemplary embodiment that follows and from the single FIGURE. In this case, all the features that are described and/or shown in the FIGURE form the subject matter of the present invention on their own or in any combination, regardless of their synopsis in the claims or the back-references therein.

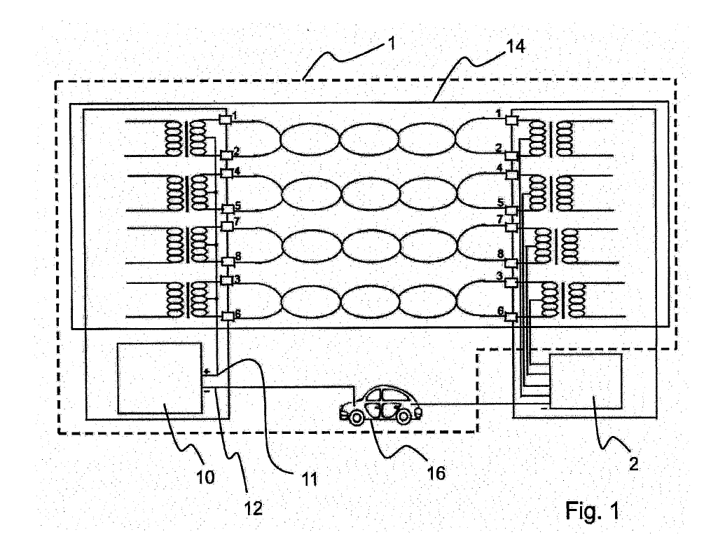

The single FIG. 1 schematically shows the apparatus for supplying power 1 according to an embodiment of the invention and the load 2 and also the interconnection thereof.

### DETAILED DESCRIPTION OF THE PRESENTLY PREFERRED EMBODIMENTS

A voltage source 10 of the power supply 1 has its first connection 11 (positive supply voltage) connected to an Ethernet cable 14, preferably to an 8-core 1000BASE-T Ethernet cable (Gigabit Ethernet). In particular, the positive supply voltage is connected in parallel with all four pairs of wires in the exemplary embodiment shown in FIG. 1. Alternatively, the first output 11 of the voltage source 10 could also be connected just to one pair of wires, or to two or three pairs of wires from the four pairs of wires.

The second connection 12 of the voltage source 10 (negative supply voltage, ground) is connected to the vehicle ground, for example the bodywork 16 of the vehicle.

At that end of the Ethernet cable 14 that is opposite the voltage source 10, the cable is connected to the load 2. The ground of the load is connected to the vehicle bodywork 16. The load 2 additionally has an interface that allows the positive supply voltage and the electric current intensity transmitted by each wire to be tapped from all four pairs of wires.

In order to overcome problems owing to an uneven distribution of the electric current intensity to the wires of the Ethernet cable 14, one preferred exemplary embodiment has a current limiter (not shown) arranged at the feed point for each pair of wires on the voltage source side, the current limiter(s) preferably being arranged in an interface (not shown) that is arranged between the first connection 11 of the DC source and the Ethernet cable 14.

In the present exemplary embodiment, the first connection 11 and the second connection 12 of the voltage source 10 typically have 12 V, in the case of an automobile, or 24 V, in the case of a truck, between them.

In contrast to the solutions for Power over Ethernet that are described in the IEEE standards, the present invention involves only the positive voltage being transmitted via the Ethernet cable 14. This can involve the use of all 8 wires or else fewer than 8 wires. The ground connection of the voltage source is at the vehicle ground. In contrast to the use of two (IEEE 802-3af) or four (IEEE 802-3at) wires (including a ground connection) based on the prior art, the current carrying capacity of the entire Ethernet cable is thus quadrupled or doubled when all 8 wires are used. The present invention therefore allows the same power to be transmitted at one quarter or half of the voltage.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-6. (canceled)

7. An apparatus for supplying power (1) to a load (2) in a vehicle with a DC voltage source (10), the apparatus comprising:
a first connection (11) of the DC voltage source (10);
a second connection (12) of the DC voltage source (12); and
a multicore line configured to transmit voltage from the DC voltage source (10) to the load (2), wherein the first connection (11) of the DC voltage source (10) is connectable to the multicore line (14) and the second connection (12) of the DC voltage source (12) is connectable to a ground potential (16).

8. The apparatus as claimed in claim 7, wherein the ground potential is formed by the vehicle ground (16).

9. The apparatus as claimed in claim 7, wherein the multicore line (14) is an Ethernet cable.

10. The apparatus as claimed in claim 7, wherein the voltage source (10) provides a voltage of 12 volts or 24 volts between the first connection (11) and the second connection (12).

11. The apparatus as claimed in claim 7, wherein a respective current limiter is arranged at a feed point for a wire or for a pair of wires in the multicore line (14).

12. A method for supplying power to a load (2) in a vehicle with an apparatus as claimed in claim 7, the method comprising:
connecting the first connection (11) of the DC voltage source (10) to the multicore line (14); and
connecting the second connection (12) of the DC voltage source (10) to the ground potential (16).
